(19) United States
(12) Patent Application Publication
(10) Pub. No.: US 2008/0310671 A1
(43) Pub. Date: Dec. 18, 2008

(54) Microspeaker with Damper in Magnetic Circuit

(75) Inventor: Shunming Yuen, Shenzhen (CN)

Correspondence Address: GLOBAL IP SERVICES, 7285 W. Eagle Court, Winton, CA, 95388, US

(73) Assignee: INNOVATION SOUND TECHNOLOGY CO., LTD., Shenzhen (CN)

(21) Appl. No.: 11/964,832

(22) Filed: Dec. 27, 2007

(30) Foreign Application Priority Data
Jun. 18, 2007 (CN) 200720121019.7

(51) Int. Cl. H04R 1/00

(52) U.S. Cl. 381/413

(57) ABSTRACT

The present invention relates to a microspeaker with a damper in a magnetic circuit. The microspeaker includes a support, a magnetic circuit in the support, a diaphragm suspended on the support, and a voice coil and a damper connected with the diaphragm. The magnetic circuit is provided at the center with a through hole where the damper is positioned, and the voice coil is positioned in a magnetic gap formed by the magnetic circuit. The microspeaker of the present invention with the damper in the magnetic circuit can not only equally control resonance but also be produced in a simpler way compared to adding damping materials to the support.

### CROSS REFERENCE TO THE RELATED PATENT APPLICATION

This patent application claims the priority of the Chinese patent application No. 200720121019.7 with a filing date of Jun. 18, 2007.

### FIELD OF THE INVENTION

The present invention relates to a microspeaker, and more particularly to a microspeaker with a damper in a magnetic circuit.

### BACKGROUND OF THE INVENTION

A common microspeaker/microreceiver is provided on a support with a hole to allow air behind a diaphragm to circulate, so as to ensure the diaphragm vibration against influences of air pressure of a rear cavity and obtain an enough low resonance frequency. In order to reduce disadvantageous influences from resonance, such as high amplitude and great distortion, damping materials can be added to the hole to control resonance. However, this kind of hole is dispersively distributed. When it is used in a product smaller than 15 mm (especially 10 mm) in diameter, production is not easy to control and the product is poor at consistency due to small size of the materials. A structural schematic view of a prior microspeaker is shown in FIG. 1. Its magnetic circuit center is in a closed state. A support 1 is provided with a through hole. A magnetic circuit is formed by a lower cleat 8, an annular magnet 9 positioned at the lower cleat 8, and an annular magnetizer for concentrating flux positioned at the annular magnet 9. A voice coil 4 is positioned in a magnetic gap formed by the magnetic circuit. The support 1 is provided inside at the upper part of the magnetic circuit with a suspended diaphragm 2, with which the voice coil 4 is connected.

### SUMMARY OF THE INVENTION

The present invention provides a microspeaker with a damper in a magnetic circuit, so as to solve the above-mentioned defects of the prior art technology.

The present invention adopts the following technical solution to solve the technical problems: A microspeaker with a damper in a magnetic circuit is presented, the microspeaker including a support, a magnetic circuit in the support, a diaphragm suspended on the support, and a voice coil and a damper connected with the diaphragm. The magnetic circuit is provided at the center with a through hole where the damper is positioned, and the voice coil is positioned in a magnetic gap formed by the magnetic circuit.

In the microspeaker of the present invention with the damper in the magnetic circuit, the magnetic circuit encircles the voice coil, therefore it is an external magnetic type. It includes a T-form lower cleat with a hollow cylindrical hole, an annular magnet positioned at the lower cleat, and an annular magnetizer for concentrating flux positioned at the annular magnet. The damper is positioned at the exterior back of the support, or at the end or inside of the through hole in the support.

In the microspeaker of the present invention with the damper in the magnetic circuit, the voice coil encircles the magnetic circuit, therefore it is an internal magnetic type. It includes an annular magnet, and an annular magnetizer for concentrating flux positioned at the annular magnet. The damper is positioned at the exterior back of the support, or at the end or inside of the through hole in the support.

The microspeaker of the present invention with the damper in the magnetic circuit has the following beneficial results: It can not only equally control resonance, but also be produced in a simpler way compared to adding damping materials to the support.

### BRIEF DESCRIPTION OF THE DRAWINGS

The present invention will be further described below according to drawings and embodiments. In the drawings:

FIG. 1 is a structural schematic view of a prior microspeaker.

FIG. 2 is a structural schematic view of Embodiment 1 of the microspeaker of the present invention with the damper in the magnetic circuit.

FIG. 3 is a sectional view along line A-A of FIG. 2.

FIG. 4 is a sectional view along line B-B of FIG. 2.

FIG. 5 is a structural schematic view of Embodiment 2 of the microspeaker of the present invention with the damper in the magnetic circuit.

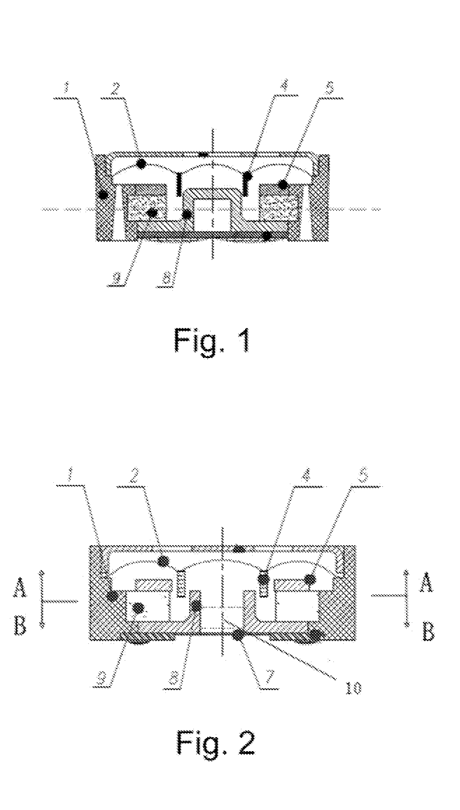

### DETAILED DESCRIPTION OF THE INVENTION

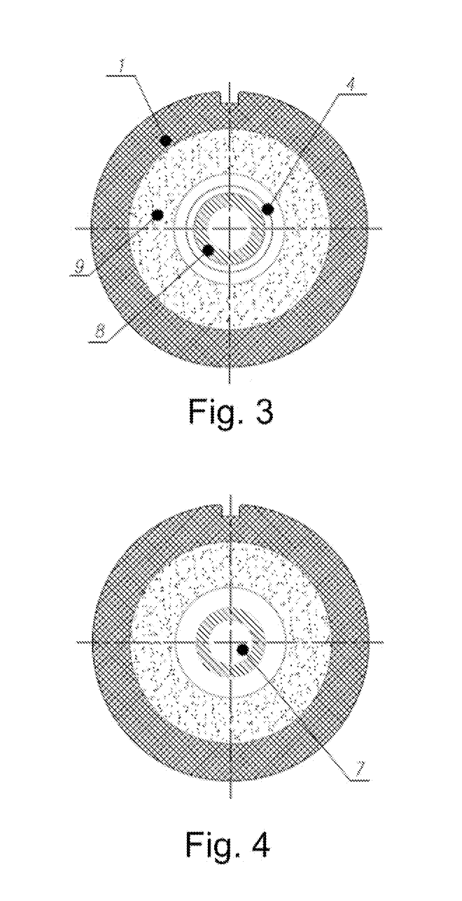

The microspeaker of the present invention with the damper in the magnetic circuit is shown in FIGS. 2-4, where the magnetic circuit is of an external magnetic type. FIGS. 3 and 4 are sectional views along the corresponding cutting plane of FIG. 2. In the microspeaker, a support 1 is provided inside with a magnetic circuit, which is provided at the upper part with a suspended diaphragm 2, with which is connected a voice coil 4, which is positioned in a magnetic gap formed by the magnetic circuit. The magnetic circuit of an external magnetic type in this embodiment includes a T-form lower cleat 8 with a hollow cylindrical hole 10, an annular magnet 9 positioned at the lower cleat 8, and an annular magnetizer 5 for concentrating flux positioned at the annular magnet 9. A damper 7 is positioned at the exterior back of the support, or at the end or inside of the through hole in the support (see the position shown by the broken line in the hole 10 of FIG. 2).

All the holes are centralized together to form a bigger single hole. Therefore, many disadvantageous factors due to small and scattered holes are solved. For a structure of an external magnetic type, cut out a hole 10 at the center of a central post (also known as a T-iron), then add a damper 7 to the hole, and meanwhile remove the hole originally in the support and any other holes that may leak air.

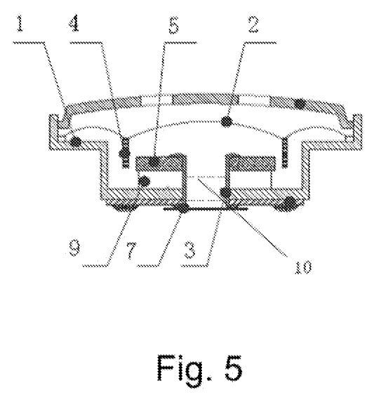

As shown in FIGS. 5, where the structure of the magnetic circuit is of an internal magnetic type. For a structure of an internal magnetic type, a hole can be cut out at the center of all washers, magnets, and magnetic bowls (when necessary a rivet can also be added at the center to facilitate magnetic circuit combination), and the damper 7 can be further added to the central hole 10 under the guarantee that no places other than the central hole 10 leak air. In this embodiment, a magnetic circuit of an internal magnetic type includes an annular magnet 9, and an annular magnetizer 5 for concentrating flux positioned at the annular magnet 9. In this magnetic circuit, the annular magnet 9 and the upper cleat 5 can be further fixed with a rivet 3.

The damper 7 in the embodiment can be positioned either at the exterior back of the support 1, or at the end or center of the through hole 10 (see the position shown by the broken line in the hole 10 of FIG. 5). No matter where it is positioned, it is acceptable as long as damping of the hole can be increased.

What is claimed is:

1. A microspeaker with damper in magnetic circuit comprising:
a support (1);
a magnetic circuit provided at the center of the support (1) with a through hole (10) where a damper (7) is positioned;
a diaphragm (2) suspended on the support (1);
a voice coil (4) connected with the diaphragm (2) being positioned in a magnetic gap formed by the magnetic circuit.

2. The microspeaker with damper in magnetic circuit according to claim 1, wherein the magnetic circuit is of an external magnetic type, the magnetic circuit encircles the voice coil (4).

3. The microspeaker with damper in magnetic circuit according to claim 2, wherein the magnetic circuit includes a lower cleat (8) with a hollow cylindrical hole, an annular magnet (9) positioned at the lower cleat (8), and an annular magnetizer (5) for concentrating flux positioned on the annular magnet (9).

4. The microspeaker with damper in magnetic circuit according to claim 1, wherein the magnetic circuit is of an internal magnetic type, the voice coil (4) encircles the magnetic circuit.

5. The microspeaker with damper in magnetic circuit according to claim 1, wherein the magnetic circuit includes an annular magnet (9) and the annular magnetizer (5) is positioned on the annular magnet.

6. The microspeaker with damper in magnetic circuit according to any of claims 1, wherein the damper (7) is positioned at the exterior back of the support (1).

7. The microspeaker with damper in magnetic circuit according to any of claims 1, wherein the damper (7) is positioned at the end or inside of the through hole (10).
